(19) United States
(12) Patent Application Publication
(10) Pub. No.: US 2014/0317008 A1
(43) Pub. Date: Oct. 23, 2014

(54) METHOD AND SYSTEM FOR PROVIDING AND CONTROLLING ACCESS TO CANDIDATE INFORMATION IN COLLECTIONS OF PARTNER COMPANIES

(71) Applicants: Richard Wilner, Needham, MA (US); Noah Zitsman, Needham, MA (US)

(72) Inventors: Richard Wilner, Needham, MA (US); Noah Zitsman, Needham, MA (US)

(21) Appl. No.: 13/865,058

(22) Filed: Apr. 17, 2013

(51) Int. Cl. G06Q 10/10

(52) U.S. Cl. CPC G06Q 10/105
USPC 705/320

(57) ABSTRACT

A non-transitory computer readable medium and a method for providing employee information in response to queries by requesting companies in accord with searching rights granted by the employer includes receiving a query comprising at least readable non-transitory memory residing within at least one network-connected server. A role-based security profile relative to the partner company's employee database allows the matching of one requested attribute at the network-connected server, from the requesting company. The server retrieves a role-based security profile associated with the requesting company to determine a subset of a partner company database comprising partner company employee data selected for access in accord with the security profile. Within the subset of the partner company database matching candidate employee data is identified as having at least one employee attribute to match the requested attribute. The candidate employee data is transmitted to the requesting company.

### FIELD OF THE INVENTION

The invention is generally a method of using a system of databases resident on servers, more specifically, the invention relies upon managing role-based permissions to grant access.

### BACKGROUND OF THE INVENTION

Sooner or later, every common business venture between two or more companies faces a similar problem: how to efficiently share information and leverage one another's human resources to achieve a common business goal, such as winning a contract or delivering a project. As part of a corporation, a manager will have ready access to information about her own people. However, obtaining a similar level of access to resource information in other companies' pools of resources can be challenging.

In a competitive environment, quickly identifying the best combination of resources within a company's collection of partner companies can make a marked difference in the likelihood of obtaining a contract award. Unfortunately for most companies, the issue becomes one similar to that of the chicken and the egg. Without the contract, a company may not have the resources to retain persons having specific skills, but without the person, they may not have the ability to perform under the contract. Within a highly competitive environment, any company will forced to choose to narrowly focus on its core strengths by garnering expertise within a specific technical area. Where new expertise is necessary, many companies are finding it wiser to hire expertise into their workforce rather than to find vendors to “fill in the gaps.” The downfall of relying upon outside vendors to fulfill parts of a contract, outside of the control of a single company has been dramatically demonstrated by the Boeing Company in the development of the 787 Dreamliner™. Companies faced with the choice between the Dreamliner™ multivendor solution and a single company fulfilling a contract would naturally prefer the latter. The economically preferable solution is to bring the expertise in house when given the opportunity to find that expertise where it exists; the trouble is locating and identifying that best-fit resource.

To describe the magnitude of the task of identifying the best-fit resource, consider a company having a number of separate subsidiaries who cooperate to secure contracts who cooperate to secure contracts but who are otherwise independent. Among the company and its subsidiaries (collectively herein one example of “partner companies”; others might include companies bound by an agreement to cooperate, etc.), there are distinct databases each holding personnel records. In order for a personnel officer within the company or one of its subsidiaries to obtain a qualified candidate from a partner company, at least three transactions are required. In the first transaction, the manager at the requesting company must communicate requirements to at least one manager at the partner company. In transaction two, the manager at the partner company must evaluate at least one individual within his company against the requirements set forth in the request. The third transaction involves the manager at the partner company communicating the candidate's qualifications to the manager at the requesting company.

If the requesting company has ten partner companies, each of which has ten available resources, a minimum of 300 transactions are required to comprehensively evaluate the possibilities in filling a single position. Further, consider that a single contract may require dozens of positions to be filled; dozens of contracts may be in play simultaneously; a company may have many more than 10 partner companies; and a company may have many more than 10 resources requiring evaluation. As each of these factors increases, the magnitude of the number of transactions required for a requesting company to obtain suitable candidates from its collection of partner companies increases geometrically, and managing these transactions becomes simply impossible. To further complicate matters, each partner company must be separately and sequentially queried in turn, resulting in a significant burden on the requesting company to manage which queries have been serviced. FIG. 1 depicts such a conventional process by and between cooperating partner companies to find such resources.

At a Gather Requirements Block 10.1, the company will collect, into a physical or electronic document, a set of requirements which describe the candidate ideally suited to complete the task, project, or job which is currently vacant. The form of this requirements document may not be a standard and familiar one to those receiving the request, which could increase the time required by the receiving company to reconcile those requirements with candidates.

At a Transmit Requirements to Partner Company Block 10.2, the requesting company will inform the receiving companies of their need for a candidate and supply them with the requirements document garnered at Block 10.1. As depicted in the conventional method shown in FIG. 1, a manager uses existing communication channels, and most typically communicating through e-mail, phone, or an in-person conversation.

The receiving companies take possession of the requirements document at a Receive Requirements Block 10.3, after which, at a Compare a Candidate to Requirements Block 10.4, a manager at the receiving company will begin an individual evaluation process wherein that manager compares the requirements with the competencies of each individual candidate throughout their organization. Because each company's manager may exercise an evaluation process that is unique to the company or to the manager, the results of each company's evaluation will weigh each of the requirements differently from those performed by the others, and also possibly differently than is the requesting company's intent. Some companies will execute this comparison activity in a completely serial fashion, where an individual manager reconciles the requirements against each individual candidate in turn. In other cases, a spreadsheet or computer program of some sort may eliminate some unsuitable candidates based on a pre-defined set of criteria, such as job title or physical location.

No matter what method a company chooses to employ or finds itself limited to (based upon available technology and resources), a manager must continue to evaluate candidates until all candidates have been considered, as depicted at a Have All Candidates Been Evaluated Decision Block 10.5A, or the time allotted for a response has expired, as shown at a Has Time Expired Decision Block 10.5B. The output of this process occurs as a Determine Best Candidate Block 10.6, where the manager responsible for performing the evaluation selects the most suitable candidate from the set of evaluated candidates.

At a Transmit Candidate Information to Requesting Company Block 10.7, the company who received the request to provide a candidate will provide the information about that candidate to the requesting company, which, in turn, takes possession of the candidate information at a Receive Candidate Information Block 10.8. Just as the requirements document generated by the requesting company is non-standard, so too is the candidate information document provided by the receiving company in response.

Whatever the format, once the requesting company receives the candidate response from a partner company, at an Evaluate Candidate Against Requirements Block 10.9, it will then undergo its own evaluation process to compare that candidate to the requirements garnered at Block 10.1. Like its partners' candidate evaluation processes, the requesting company will employ the manual comparison of candidate information, augmented by whatever electronic tools are at its disposal, to complete the reconciliation of candidate information against requirements. Thus, each candidate must undergo a minimum of two manual reconciliations against requirements, one each at the receiving company and the requesting company, and sometimes many more than that if multiple evaluators are involved. Further, the potential for significant inefficiency exists because both the requirements document and the candidate information document are non-standard in general which hinders at best, or makes impossible at worst, the use of automated, algorithmic tools.

The requesting company may have queried all its partner companies simultaneously; however, each company's evaluation process and response is asynchronous. Only when the requesting company has received substantially all the responses from its partner companies, it can proceed with the evaluation of candidates as depicted by a Have All Responses Been Received Decision Block 10.10; if it has not, the company must decide if the evaluation can be further delayed, as shown at a Can Evaluation Be Delayed Decision Block 10.11. The decision to delay the evaluation is particularly troublesome because it is based on many factors that carry a cost but are difficult to discern or are explicitly unknowable, such as how quickly competitors will provide their candidates for the same opportunity, or if one of the partner companies that has yet to respond will provide the best candidate with the highest likelihood of securing the opportunity.

If the requesting company decides that waiting for more companies to reply is prudent, it will delay its evaluation and selection process at a Wait for Additional Responses Block 10.12. If, however, delay is not the best business decision, the requesting company will then select the best candidate from the candidates responses supplied at a Select Best Candidate Block 10.13.

When faced with managing this quantity and complexity of transactions represented by FIG. 1, most managers within partner companies abandon any attempt to service requests for candidates using regimen or rigor, rather a manager will select candidates from its collection of partners based simply upon which partner company responds first, personal likes and dislikes, chance meetings, and simple guessing. In some cases, the workload associated with performing these transactions may drive a company to choose not to respond to a query at all, without determining whether or not a suitable candidate is available. As a result, companies may lose contract awards where they otherwise may have won them.

What the art lacks is a system for, and a method of, providing direct visibility into the resources within a collection of partner companies' candidate pools, and both initiating and managing those requests in a cohesive fashion.

### SUMMARY OF THE INVENTION

By allowing a company to directly access and query its partner companies' candidate information, the number of transactions required for a requesting company to obtain candidates from its collection of partners is reduced in at least two ways: first, by eliminating both the need for a partner company to query its candidates; and second, by eliminating the need for the partner company to communicate the candidate information to the requesting company. Further, direct visibility eliminates the need for the requesting company to wait for the partner company to respond which, based on the partner company's workload, may be delayed beyond the useful life of the requesting company's query. The number of transactions can be further reduced by removing from consideration those candidates which are consumed, ill-suited, or otherwise unavailable to partner companies. Finally, by providing a cohesive location to initiate and manage resource requests, companies can minimize or eliminate the overhead and confusion that often accompanies the resource sharing transactions.

A non-transitory computer readable medium and a method for providing employee information in response to queries by requesting companies in accord with searching rights granted by the employer includes receiving a query comprising at least readable non-transitory memory residing within at least one network-connected server. A role-based security profile relative to the partner company's employee database allows the matching of one requested attribute at the network-connected server, from the requesting company. The server retrieves a role-based security profile associated with the requesting company to determine a subset of a partner company database comprising partner company employee data selected for access in accord with the security profile. Within the subset of the partner company database matching candidate employee data is identified as having at least one employee attribute to match the requested attribute. The candidate employee data is transmitted to the requesting company.

### BRIEF DESCRIPTION OF THE DRAWINGS

Preferred and alternative examples of the present invention are described in detail below with reference to the following drawings:

Preferred and alternative examples of the present invention are described in detail below with reference to the following drawings:

FIG. 1 is a flow chart indicating a common method of requesting candidates from partner companies, the shortcomings of which are overcome by the method;

FIG. 2 is a summary flow chart indicating the method of connecting with partner companies, obtaining candidates from a collection of partner companies, and managing requests for candidates within the collection of partner companies, enabled by direct visibility into partner company information via the method;

FIG. 3 is a first diagram depicting the three different configurations, made available by the method, of determining how a company receives requests to connect its database to other companies' databases;

FIG. 4 is a first detail flow chart describing how the method establishes and configures connections between the employee information databases of two or more companies;

FIG. 5 is a non-limiting example of a first interactive form which collects myriad fields, by which a company may configure and limit the information available in the connection of its employee information database to another company's database;

FIG. 6A is a second diagram depicting the resultant topology of the connections between companies' employee information databases enabled by the method;

FIG. 6B is a third diagram depicting a non-limiting example of a preferred physical embodiment, which enables the method to be implemented and reduced to practice using common hardware and software components;

FIG. 7 is a second detail flow chart describing how the method manages candidate requests within collections of companies whose employee information databases are connected by the method;

FIG. 8 is a non-limiting example of a second interactive form that collects and provides access to both outgoing and incoming requests for candidates within collections of companies whose employee information databases are connected by the method.

### DETAILED DESCRIPTION OF THE PREFERRED EMBODIMENT

In many industries, a company will seek out, develop, and maintain both formal and informal relationships with other companies that have complimentary capabilities. The resulting partnership creates more business opportunity than either company could enjoy individually. Indeed, a company may choose to specialize in a very narrow, focused area, such as becoming an expert with a single programming language or becoming particularly adept with a certain manufacturing process, and form a number of partnerships with companies that have a need for this focused capability.

A non-transitory computer readable medium and a method for providing employee information in response to queries by requesting companies in accord with searching rights granted by the employer includes receiving a query comprising at least readable non-transitory memory residing within at least one network-connected server. A role-based security profile relative to the partner company's employee database allows the matching of one requested attribute at the network-connected server, from the requesting company. The server retrieves a role-based security profile associated with the requesting company to determine a subset of a partner company database comprising partner company employee data selected for access in accord with the security profile. Within the subset of the partner company database matching candidate employee data is identified as having at least one employee attribute to match the requested attribute. The candidate employee data is transmitted to the requesting company.

Throughout this application at least two words will be used wherein the applicant intends that they be given a particular meaning. The terms “attribute” or its plural “attributes” will generally be a subset of the term skill set. Most often, “attribute,” where used, may be used as a synonym for “skill.” However, there are some qualities, such as physical strength or height in stature that may also be attributes but do not fall formally within the traditional term “skill.” For this reason, the broader term “attribute” is used herein to allow for a more inclusive expression and explanation of the claimed invention. Another term that is used and asserted herein is “match.” Match, as used herein, does not require a perfect match. Rather, as used in this application, matching means fuzzy matching. Fuzzy matching is an advanced mathematical process that determines the similarities between data sets, information, and facts where the outcome is neither true nor false, or 100 percent certain, hence the word, “fuzzy.” The process compares any data type of any length and from any place in a field to find non-exact matches.

While the applicant lays no claim to the process of fuzzy matching, this application does employ fuzzy matching and any reference herein to matching does mean fuzzy matching. Fuzzy matching or fuzzy logic is “applied to fuzzy sets where membership in a fuzzy set is a probability, not necessarily 0 or 1. Fuzzy logic needs to be able to manipulate degrees of maybe, in addition to true and false.” That probability is employed as a criterion in rating the match where it is not unity or an exact match, the data is shared down to a certain configurable threshold. Thus, for example, for every piece of data examined, the fuzzy matching process will give a probability score to determine the accuracy of the match. For example, ‘Tomas Jones’ might get a 90 percent score of similarity, while ‘Tom Jones’ might receive a 75 percent score, as compared to the actual name of Thomas Jones.

An additional scoring criterion is generated from skills or attributes that may overlap. Pipefitters may specialize in one type of pipe as in the use of stainless steel pipe in the nuclear power industry. Techniques used there are far more rigorous than those used, for example to install fire suppression sprinkler systems out of iron pipe. Still less rigorous is the use of pip in general to plumb a residence. In any regard, however, one would assume that a person facile in fitting stainless steel pipe could readily adapt to fitting PVC pipe or steel pipe in either of the other two applications. For that reason, where applicable, the invention will modify scores for matching to include telescoping sets of skills of mounting rigor as well as related skills that, while distinct, are so closely related that aspects ought to transfer from one position to another.

Still another aspect of matching is implemented where a certification is necessary to practice a skill such as journeyman status, commercial licensing for pilots, hardhat diving, etc. In this aspect of the invention, certain attributes reflect an “uphill” and “downhill” relationship. Referring back to pipefitting, a journeyman plumber might well qualify as an apprentice to a stainless steel pipefitter but cannot work without the supervision of a journeyman stainless steel pipefitter on certain tasks. Thus for a single pipefitter position, the exemplary plumber may not serve and is not a match but may be available to fill a position as a second stainless steel pipefitter in another opening. Thus, the matching algorithm, not here claimed, must be considered as within the scope of the term, “match” wherever used herein.

The management of a company's relationships with other companies can become complicated when there is an overlap in the companies' capabilities. Consider two companies, one of which manufactures and installs steel pipe, and another of which manufactures and installs iron pipe. In a case where a contract specifies some quantity of stainless pipe and some quantity of iron pipe be furnished and installed, these two companies complement one another in common pursuit of a contract. In a case where a contract specifies only that pipe be furnished and installed and the material of construction is of no consequence, these two companies would be competing with one another for the same contract. Thus, depending on changing business conditions, the two companies may choose to either share information with one another or not.

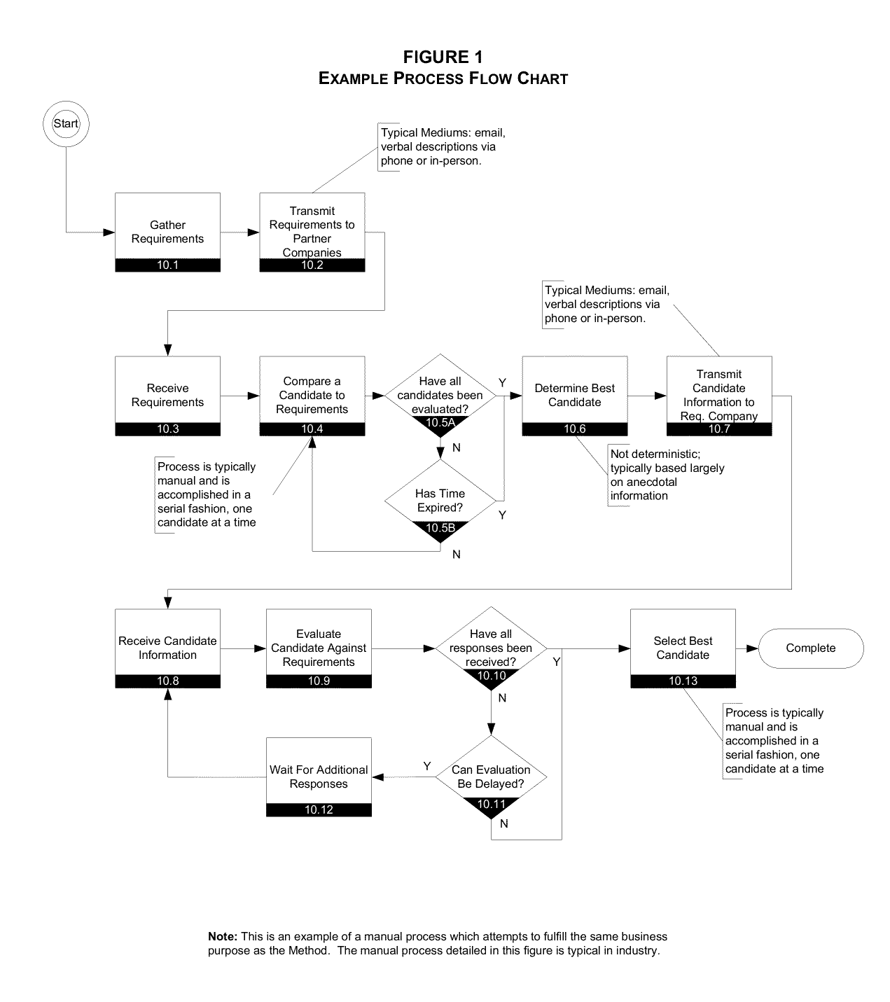

Even if the relationship a collection of companies share and exploit for mutual benefit is relatively unchanging for a period of time, the methods available to them which enable the sharing of employee information are inefficient. This inefficiency is due to myriad factors, the largest of which are the serial nature by which they must interact with one another and the dependence on manual transactions. A typical process by which one company would query its collection of partner companies to discover, evaluate, and engage a resource for an engagement has been previously set forth in the background discussion relating to prior art shown in FIG. 1. The depicted process, while functional, requires a great deal of manual intervention on behalf of all involved parties, and requires the synthesis and comparison of candidate data from sources in different locations and in different formats. The result is to increase direct costs for the companies in the form of configuring and servicing requests, and increased indirect cost caused by lost business due to delays in building teams to secure contracts and service clients.

A method and system for providing direct and controlled visibility into a partner company's records relating to individual workers and management of candidate requests includes three main components: first, computer elements to facilitate access to stored databases of worker information; second, logical controls implemented in hardware and software to limit information access based on ad-hoc business rules and requirements; and, third, an interface to initiate and to service requests for information. The interface-implemented system of information controls allow the method to accurately adjust to and reflect a company's changing relationships with other companies as they are formed, modified, and dissolved throughout the company's life span.

The method exploits a connection between a company's database of employee information, already in machine-readable form, and one or more additional companies' databases of machine-readable employee information. These databases must store the information in a manner such that through the use of an appropriate interface, each user can process, and display data stored in a partner. It is envisioned that mapping may be necessary to extract similar data from distinct databases but the accuracy of the results is greatly dependent upon the similarity of information when entered in either database.

Two types of information are either generated or shared to enable the system to foster trust among the partner companies. The first type is the actual employee data, the target of the search; this data enables a manager to determine if a candidate is a viable match for a position. The data is that necessary to document a person as a candidate and comprises the familiar fields such as name, contact information, skills, experience, availability, geographic location. The second type is a log of transactional data; selected to provide records of the request and the exchange of information between companies, and comprises fields such as requestor, time, date. Importantly, this second type of data includes, as well, the business rules and logic that govern data privacy and exposure. With each search being logged, there is an accountability introduced that would not be present

The system includes a network and at least one server on that network to facilitate one company's ready, direct access to other companies' employee information. Providing network and the computer communication it facilitates through computer-enabled links allows the method to eliminate the conventionally-required transaction, the act of the company requesting access to that information through an external request, often performed by a manager, to the partner company, as previously set forth in FIG. 1 Block 10.2. Further, because the connected company's information is stored on a server in a format compatible with the requesting company's database, the requesting company can view the connected company's resource information in a familiar format.

The method is enabled by at least one server which, among other things, collects all of the individual connected databases such that the information contained within the collection of connected databases can be quickly and simultaneously accessed on-demand. Further, the method controls the flow of information from the company to its partners as that information flows through the collection of connected companies via a configuration for each company which embodies roles and security, which principally limits two aspects of information exposure: first, which individual candidates will be exposed to requests from connected companies, and second, what information about those candidates can be accessed. The server can be uniquely configured to facilitate types of requests and layers of access distinctly for each connection in this regard. Finally, the server collects, stores, and processes both incoming requests for candidates from the companies in the partner network and outgoing requests made to companies in the partner network.

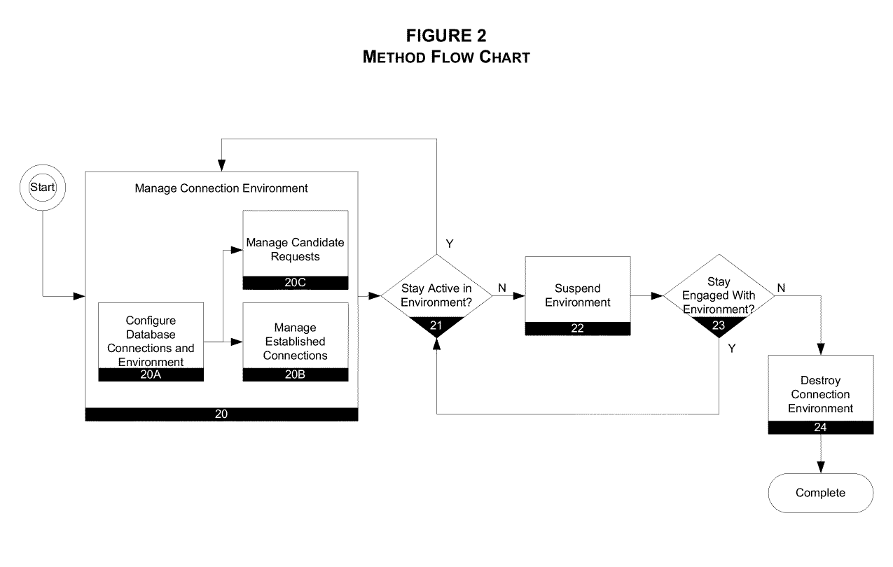

FIG. 2 is an overview flow chart indicating a method performed by at least one server to establish, manage, and sever connections across and between the employee information databases within a collection of companies, directly access partner companies' employee information through the shared, configured database connections established by the method, and manage requests to engage individual employees within collections of connected companies.

At a Manage Connection Environment Block 20, the server performing the method provides the ability for a company to establish and manage the data and business rules which govern the interaction of its employee information database and those of other companies' databases. With role-based access control (RBAC), access decisions are based on the roles that individual users have as part of an organization. Users take on assigned roles (such as manager, human resources director, administrative assistant, etc.). Under the RBAC framework, users are granted membership into roles based on their competencies and responsibilities in the organization. The operations that a user is permitted to perform are based on the user's role. User membership into roles can be revoked easily and new memberships established as job assignments dictate. Role associations can be established when new operations are instituted, and old operations can be deleted as organizational functions change and evolve. This simplifies the administration and management of privileges; roles can be updated without updating the privileges for every user on an individual basis. In the inventive method, distinct roles and privilege bundles are configured for individuals from partner companies. As expressed above, individuals defined in such roles will also have their access logged in the second form of data generated as discussed above in order to memorialize their access.

At a Configure Database Connections and Environment Block 20A, the method establishes and configures connections between two or more companies' repositories of employee information. A properly-administered RBAC system enables users to carry out a broad range of authorized operations, and provides great flexibility and breadth of application. System administrators can control access a defined role from a partner company is granted at a level of abstraction that is natural to the way that enterprises typically conduct business. This is achieved by statically and dynamically regulating users' actions through the establishment and definition of roles, role hierarchies, relationships, and constraints. Thus, once an RBAC framework is established for an organization, the principal administrative actions are the granting and revoking of users into and out of roles. This is in contrast to the more conventional and less intuitive process of attempting to administer lower-level access control mechanisms directly (e.g., access control lists [ACLS], capabilities, or type enforcement entities) on an object-by-object basis.

From time to time, changing business conditions may require a company to either modify or sever established connections between its database of employee information and other companies' databases. The method provides this capability at a Manage Established Connections Block 20B.

At a Manage Candidate Requests Block 20C, the server or servers practicing the method initiates requests, on behalf of a first company consistent with the role the system has assigned, for candidates within that company's collection of connected companies. Further, according to the method, the at least one server collects these candidate requests and provides tools for individuals within the collection of companies to service each request.

At a Stay Active in Environment Decision Block 21, an individual at a partner company can decide to either remain actively connected to, and participating with, its partners, or choose to become inactive. In the RBAC environment, an administrator at each partner company can elect and assign the access granted to the other partner companies without the intervention of those companies so that each owner of each database can elect to expose or to conceal any particular employee within the database from particular roles defined among the several partners. On the other hand, to remove all employees from partner searches, a company elects an inactive status. A company may choose to become inactive, either temporarily or permanently, for myriad reasons, for example: a company may suspect that one or more connections are either configured improperly or are being used in an inappropriate manner. Should the company choose, it can utilize the method to temporarily or permanently suspend all connections at a Suspend Environment Block 22.

At a Stay Engaged With Environment Decision Block 23, a company may choose to permanently disable, or delete, the connections established for it by method; for example, a company may choose this option if the company's suspension of its activity within the partner community via the method lasts for a protracted time period or if the company becomes insolvent. The method provides a provision for the option to permanently delete these connections at a Destroy Connection Environment Block 24.

The method provides the ability for a company to continuously configure new database connections and its connection environment, manage established connections, manage candidate requests, or temporarily suspend its connected environment for as long as that company desires to stay engaged with its network of connected partners through the method.

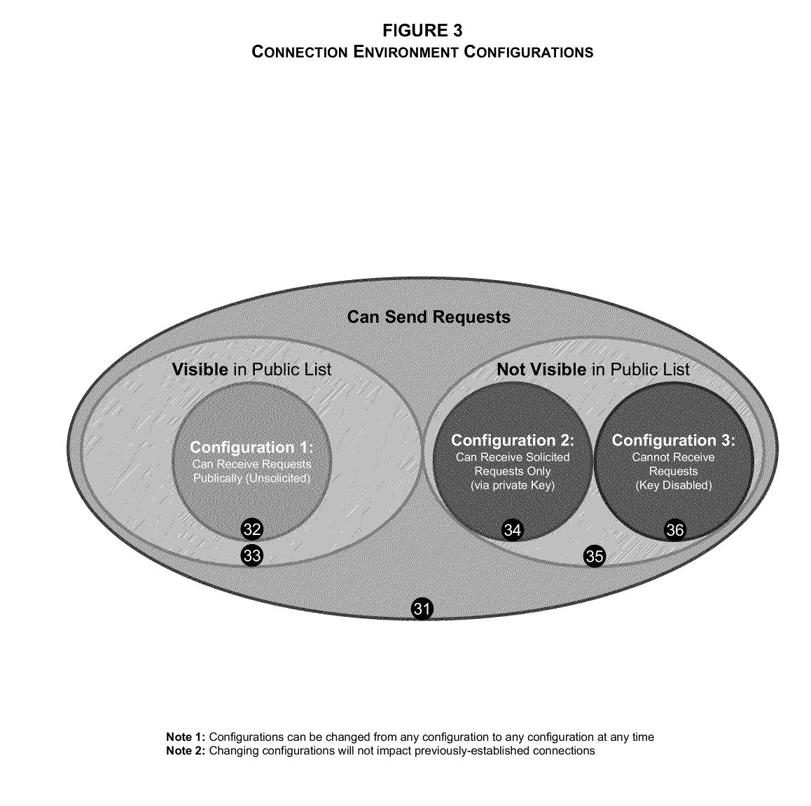

The method provides the ability for a company to control how other companies initiate database connection requests with it. Specifically, the method provides three different connection environment configurations, of which only one can be active at any given time. These three configurations are described below and are depicted pictorially in FIG. 3.

All the three different configurations do not limit a first company's ability to initiate a request with a second company, insofar as the second company's configuration allows the first company to initiate the request. The ability of a company to initiate requests via the method is depicted by a Can Send Requests Container 31, which encompasses all three configurations made available by the method.

Some companies, whose databases of employee information are managed by the method, may desire to create as many connections to other companies' databases as possible. This may be the case for a small company with a focused specialty. On its own, this company may find it difficult to create sustaining business or grow beyond a certain plateau due to the specialized nature of their work; however, by connecting its employee information database to other companies' databases which have complimentary capabilities, the first company's database of employee information will be readily accessible to other companies, which will increase the scope and reach of the projects available to the company. In the first environment configuration provided by the method, shown at a Configuration 1 Container 32, a company is exposed in a public list, depicted by a Visible in Public List Container 33, which is made accessible, by the method, to all companies which have access to databases managed by the method. In this configuration, any company whose database is accessible by the method can utilize the method to request to become connected the company.

Some companies, whose databases of employee information are managed by the method, may desire to build a collection of companies whose databases are connected to their own, without publicly exposing their company to requests. This could be the case for a very large company which deals in a large volume of projects and transactions. Such a company may receive requests from other companies who would benefit from establishing a database connection, but the magnitude of the benefit for the first company would be significantly less or zero, making the connection undesirable from the first company's perspective. Thus, the method provides a second environment configuration, depicted by a Configuration 2 Container 34, in which a company can choose to prevent itself from being exposed in the public list, as depicted by a Not Visible in Public List Container 35. The method then provides the company with a unique, randomly-generated keycode which can be privately shared with other companies. This keycode, when shared by the first company with other companies, gives other companies the ability to submit connection requests, via the method, to the otherwise-hidden first company for consideration. In this way, the method ensures the company can both establish desirable connections, and limit, or eliminate altogether, undesirable or unsolicited requests.

Once a company has established a set of connections, it may wish to temporarily or permanently prevent new incoming connection requests. This could be the case for a company once it has established all the connections it needs or if a company is establishing a secured and isolated network, for example, to service a government contract requiring security clearances. Thus, the method provides a third configuration, depicted by a Configuration 3 Container 36, in which a company is both hidden from the public list, as depicted by Container 35, and is inaccessible by a key. This configuration prevents the method from requesting new connections with the company on another company's behalf, although any connections previously established will remain intact.

Each of the three configurations made available by the method controls the means by which an incoming request can be delivered to a company. In all configurations, there is no further limitation placed on a company's ability to initiate a request; that is, in all configurations, a first company can send a connection request to a second company according to the configuration the second company has chosen.

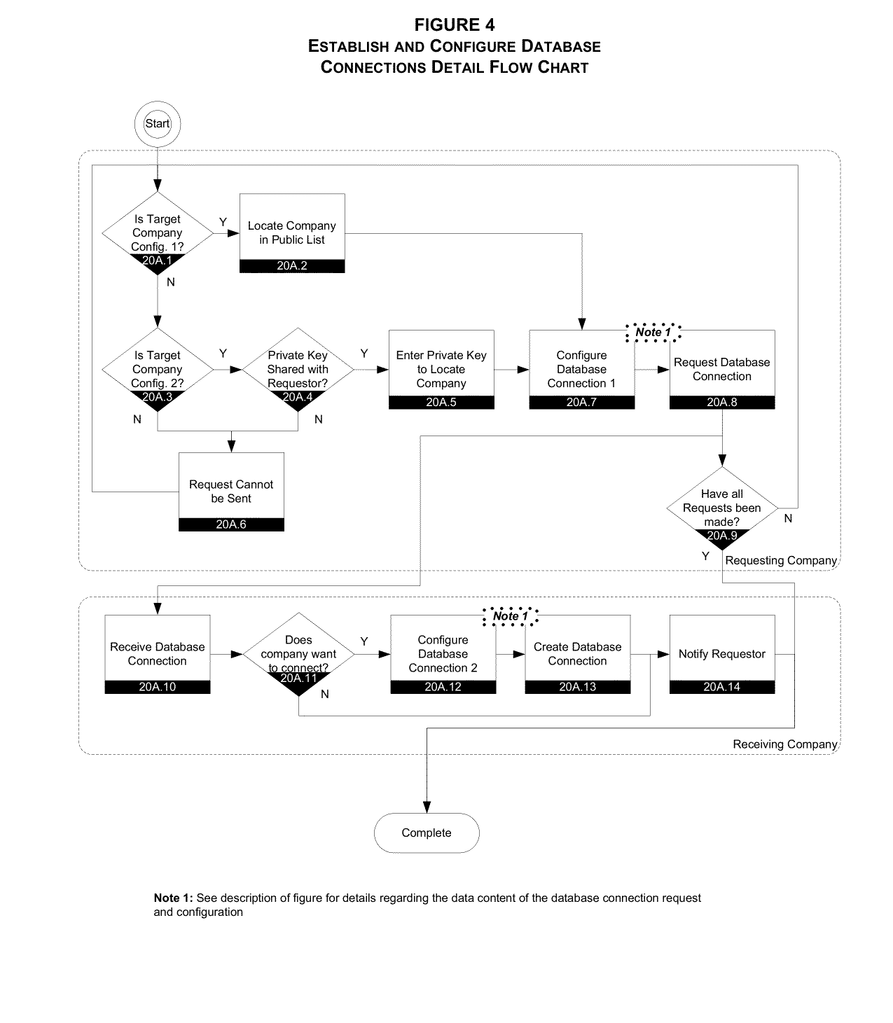

FIG. 4 is a first detail flow chart, expanding the Block 20A set forth in FIG. 2, where the method requests, establishes, and configures connections between two or more companies' repositories of employee information. The means by which a first company can request to connect with a second company via the method is determined by the configuration of the second company, as previously described and set forth in FIG. 3.

At an Is Target Company Configuration 1 Decision Block 20A.1, the method will either expose or hide a company from the publicly advertised list. If a second company has chosen Configuration 1, at a Locate Company in Public List Block 20A.2, a first company will utilize the method, or a computer implementing the method, to identify the second company that has chosen to advertise their desire to connect in a public list maintained by the method.

In the case that a company has not chosen Configuration 1, at an Is Target Company Configuration 2 Decision Block 20A.3, the method will either enable or disable a company's private key. If a first company's private key is enabled by having chosen Configuration 2, a second company can only request a connection with the first company if the first company has shared their private key with the second company, as depicted at a Private Key Shared with Requestor Decision Block 20A.4.

In the case that a first company has both select Configuration 2 and chosen to share their private key with a second company, at an Enter Private Key to Locate Company Block 20A.5, a second company will utilize the method to identify the first company.

In the case that the first company has, in the first place, chosen not to make itself available on the publically advertised list, and, in the second place, chosen either to not share its private key with the second company, or has chosen Configuration 3 thereby disabling its private key altogether, then at a Request Cannot be Sent Block 20A.6, the second company's attempt to identify the first company through the method cannot proceed.

The database connections provided by the method create the ability for collections of companies to directly view the information residing in one another's databases. However, based upon circumstance, one company may wish to limit or restrict the visibility of certain information on a case-by-case basis. For example, consider that a first company may wish to prevent a second company from contacting its resources directly; in this case, the first company would desire to keep private any contact details, such as email address, mailing address, and phone number. Further, consider that a first company may have a resource that is earmarked for full-time work on internal projects, and is thus unavailable to any external companies for project assignments; in this case, the company would choose to keep any information about this resource, and perhaps even the fact that this resource was in the employ of the company, from being exposed to other, connected companies.

At a Configure Database Connection 1 Block 20A.7, the method provides to the requesting company the ability to either expose or keep private any specific employee, piece of data, or category of data present in its database of employee information. Further, a single configuration is unique to a single connection between two companies' databases; that is to say, the method applies a separate, although not necessarily unique, configuration of information exposure to each connection made to another company's database of employee information.

At a Request Database Connection Block 20A.8, the method initiates a request on behalf of a first company to connect the first company's database of employee information to a second company's database of employee information. The data present in this request consists of, at a minimum, the requesting company's name, the receiving company's name, the requesting person's name, and a timestamp corresponding to the initiation of the request. For the purpose of servicing and handling these requests, a computer implementing the method may, in some embodiments, abstract human-readable forms of data, such as company names and individual names, to formats more convenient for the processing of data, such as database node ID numbers. This request notification is delivered to the second company in one or more myriad electronic forms, e.g., email, text message, and the like. In some cases, but not necessarily, requests to connect will be initiated between companies that already enjoy some type of partnership, either formal or informal, prior to the request being initiated.

A company may desire to initiate multiple requests to connect with other companies, and possibly a great many requests, depending on the size and scope of that company's business and business partnership landscape. At a Have All Requests Been Made Decision Block 20A.9, the method allows the company to continue to initiate requests until all the desired connections have been initiated on behalf of the company via the method.

At a Receive Database Connection Block 20A.10, the method logs the request on behalf of the receiving company and provides a means for an individual at the receiving company to review the first company's request to connect.

At a Does Company Want to Connect Decision Block 20A.11, an individual or group at the company receiving the request decides whether or not to accept the requesting company's offer to connect and communicates this decision to the method.

Should the receiving company desire to connect its database to the company initiating the request, data the receiving company exposes is based upon profiles it constructs in order to make specific data available to the requesting company. At a Configure Database Connection 2 Block 20A.12, the method provides to the receiving company the ability to either expose or keep private any specific employee, any group of employees, piece of data, or category of data present in its database of employee information, just as the method provided this ability to the requesting company at Block 20A.7.

At a Create Database Connection Block 20A.13, the receiving company indicates its desire to connect with the first company to the method, after which the method creates a connection between the initiating company's repository of employee information and the receiving company's employee information repository. A computer implementing the method will configure a set of flags which enable the two companies to access one another's information according to the connection configurations set forth in Blocks 20A.7 and 20A.12.

Once the receiving company has indicated to the method a response to the requesting company's connection request, whether that response is affirmative or negative, the method will provide to the requesting company an indication of the receiving company's response, as depicted by a Notify Requestor Block 20A.14. This response notification is delivered to the requesting company in one or more myriad electronic forms, for example, email, text message, and the like.

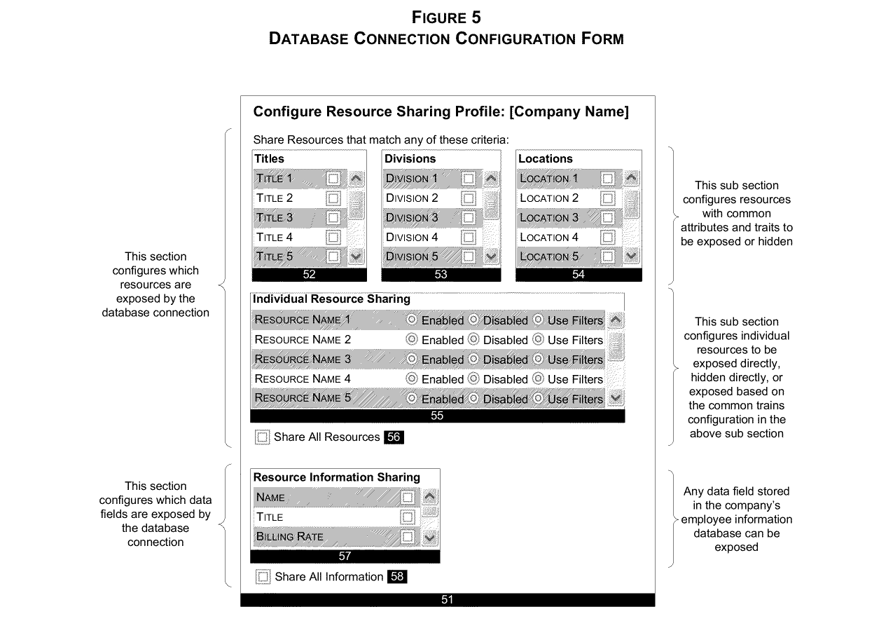

As previously set forth in FIG. 4 Block 20A.7 and Block 20A.12, upon initiating a connection, the method provides the ability for a company to define the business rules governing the connection of two companies' databases by the method. Over time, the nature of the business relationship between two companies can change. For example, a first company may routinely subcontract a specialized service, such as the configuration and maintenance of a server that is no longer supported by the manufacturer, to a second company for a period of months or years. At some point, the first company may decide to directly hire resources to perform that specialized service instead of subcontracting the services to the second company. Similarly, the second company may decide to change its focus and reallocate or divest itself of the resources that performed the specialized service for the first company. Based on these changes, a either company may wish to modify the business and data rules it established when it first created a connection the other. The method provides the ability to modify connections already established by it at a previously set forth Block 20B in FIG. 2. Initial configuration of, and modifications or updates to, connection details are communicated by the company to the method through an interactive form, a non-limiting example of is set forth in FIG. 5 at a Configure Resource Sharing Profile Form 51.

The configuration captured by the method controls principally two categories of information: which resources in the company's employ will be exposed to a partner company (“who is shared”), and which data fields made accessible to the method will be exposed to a partner company (“what is shared”). A company may find it convenient, based upon the way it is organized, to either share or hide all resources with certain common attributes. For example, an air conditioning equipment manufacturing company may choose to share the portion of its workforce dedicated to fixing air conditioning systems installed at customer sites, but may choose to hide that portion of its workforce dedicated to maintaining its internal systems. At a Titles Block 52, a Division Block 53, and a Location Block 54, the method provides a way for an individual to select or deselect common attributes for the purposes of sharing or hiding the individuals possessing these attributes with an individual partner company. These three attributes are shown by way of non-limiting example, and a great many more attributes may be made accessible by the method, such as pay grade, business unit, department, and the like.

In certain cases, a company may choose to generally share all resources with a common attribute, but take a small number of exceptions. For example, an engineering construction company may choose to share all engineers at its location in Boston, Mass., to represent that they are available to complete work and are billable, but it may choose not to expose the directors and senior managers that run that location since their activities focus on business development and day-to-day operations and are generally not billable. At an Individual Resource Sharing Block 55, an individual configuring the resource sharing profile can choose one of three sharing modalities for each resource within the company. In the first modality represented by the “enabled” option, the common attribute selections are overridden for this particular resource and their information is explicitly shared. In the second modality represented by the “disabled” option, the common attribute selections are overridden for this particular resource and their information is explicitly hidden. In the third modality represented by the “Use Filters” option, the resource's information will be exposed or hidden based upon the common attribute selections.

The method provides the ability for a first company to share information about all its resources with a second company at a Share All Resources Block 56. Block 56 allows an individual to communicate this intent to the method in a convenient way without having to check each individual box in the section containing common attributes.

A first company may wish to hide certain resource details from a second company. For example, certain information captured by the method and available to a company's internal users may be sensitive, such as billing rate or the manager to whom they report. Additionally, a company may choose to hide certain pieces of data for business reasons; for example, by hiding a resource's name, mailing address, email address and phone number, a first company will prevent a second company from directly contacting the first company's resources, and will therefore require that the second company use an alternative channel to initiate a resource request, such as the channel provided by the method. At a Resource Information Sharing Block 57, the method allows an individual configuring the resource sharing profile to either share or hide the individual resource information components warehoused by the company's resource information database and accessed by the method.

The method provides the ability for a first company to share all of the available information components about the resources it has made accessible to a second company via the method at a Share All Information Block 58. Block 58 allows the user to communicate this intent to the method in a convenient way without having to check each individual box in the Resource Information Sharing Block 57.

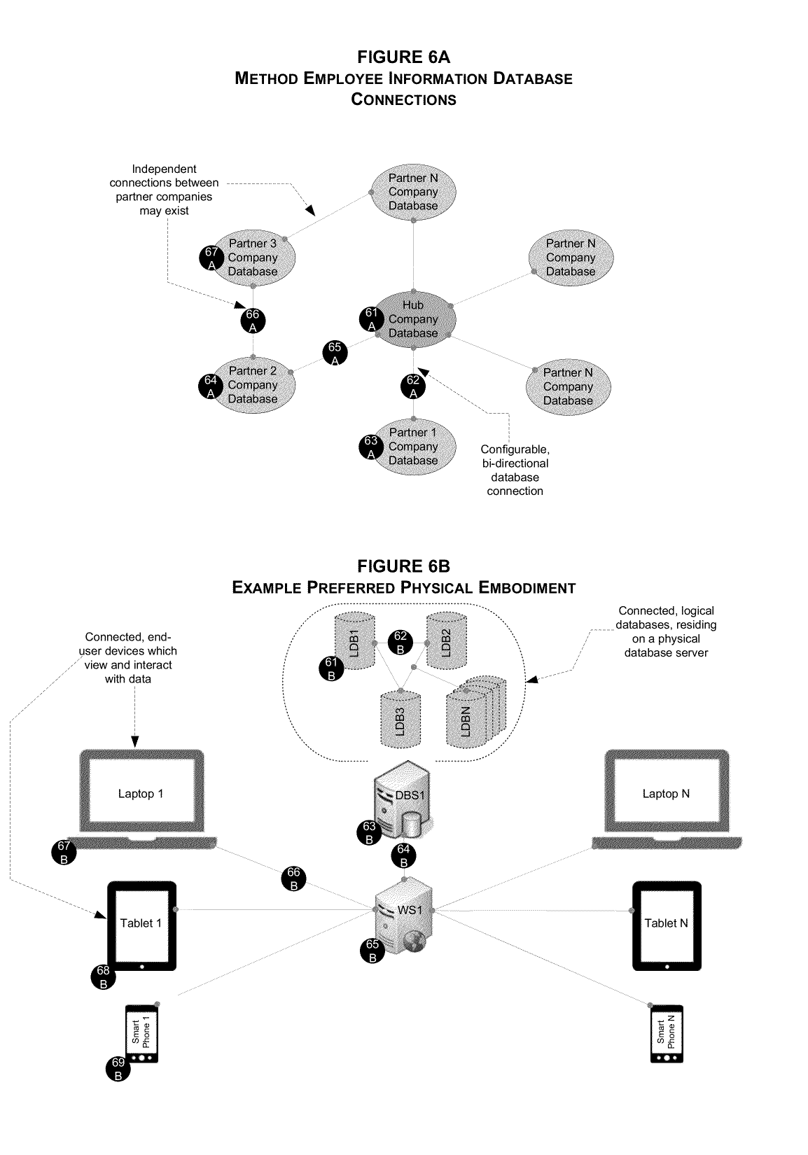

The method provides the ability for a company to request as many connections as it desires between its database of employee information and other companies' databases. Requests can be initiated by the method on behalf of a company at any time. The resulting connections, when represented schematically, resemble a hub-and-spoke, network-like architecture, a non-limiting example of which is shown in FIG. 6A. A detailed explanation of this schematic representation follows.

The partner networks established for each individual company by the method are company-centric; that is to say, each individual company is, from its perspective, at the logical center of its network of connected partners. This is represented at a Hub Company Database Block 61A.

As previously set forth in discussion of FIG. 4, connections are initiated, established, and configured by the method on behalf of both the hub company and its partner companies. An established, configured connection between the hub company and a second company is represented at a Connection Line 62A and a Partner 1 Company Database Block 63A.

It is likely that any company to whom the hub company connects will, in turn, have its own network of connected companies that have been established and configured for it by the method. A third company, represented at a Partner 2 Company Database Block 64A, is connected to the Hub Company through the method, represented by a Connection Link 65A; this third company is also connected to a fourth company, represented at a Connection Line 66A and a Partner 3 Company Database Block 67A. Each company's connection network is established and managed independently of the others by the method.

The logical arrangement of databases and connections depicted in FIG. 6A, and the method's functionality as described throughout this document, can be physically implemented using common, commercially-available software and hardware components, a non-limiting example of which is depicted in FIG. 6B and described further below.

At an LDB1 Block 61B, the method collects and stores a company's collection of employee information in a logical database, which it then, in turn, connects to other companies' logical databases of employee information, as shown at a Connection Link 62B. These logical databases and connections may reside on separate physical computers or, as shown in the preferred embodiment at a DBS1 Block 63B, they may reside on a single database server. In general, the circumstances of physical residence shall have no substantive impact on the logical and data-driven interaction between the logical databases facilitated by the method; the arrangement is instead chosen based on other factors, such as cost, availability of hardware, and performance considerations.

At a Connection Link 64B, the database server containing the collection of logical databases and connections is itself connected to a webserver shown at a WS1 Block 65B. The method primarily utilizes the webserver and connection to access the data stored in the logical databases previously set forth for the purpose of translating and formatting the data from its native machine-readable form into a human-readable form, suitable for display on myriad devices.

While a single webserver is shown in the preferred embodiment, the method may utilize several, and possibly a great many physical and logical computers, networked together to perform this task. In addition, while the webserver's primary function is to format machine-readable data into human-readable form, the method may also utilize the webserver or webservers to perform a multitude of other tasks, including but not limited to arbitrating the connection of external devices, detecting and preventing intrusions, and reporting usage statistics.

At a Connection Link 66B, the method allows external devices to interact with the webserver in order to provide end users the ability to access, modify, and configure the data maintained on their behalf by the method. These external devices can be one or more of myriad commercially-available devices, as represented in a non-limiting fashion by a Laptop 1 67B, a Tablet 1 Block 68B, and a Smart Phone 1 Block 69B.

In order to facilitate the ease with which an end user can access the data for business benefit, the method utilizes software designed for the display of and interaction with machine readable data which runs on the devices previously set forth in Block 67B, 68B, and 69B. By way of non-limiting example, this software could be a commercially-available internet browser, such as Mozilla Firefox, Google Chrome, Microsoft Internet Explorer, or Apple Safari; alternatively, a bespoke, native application designed and built specifically to run on the target device and to interact with the method may be used.

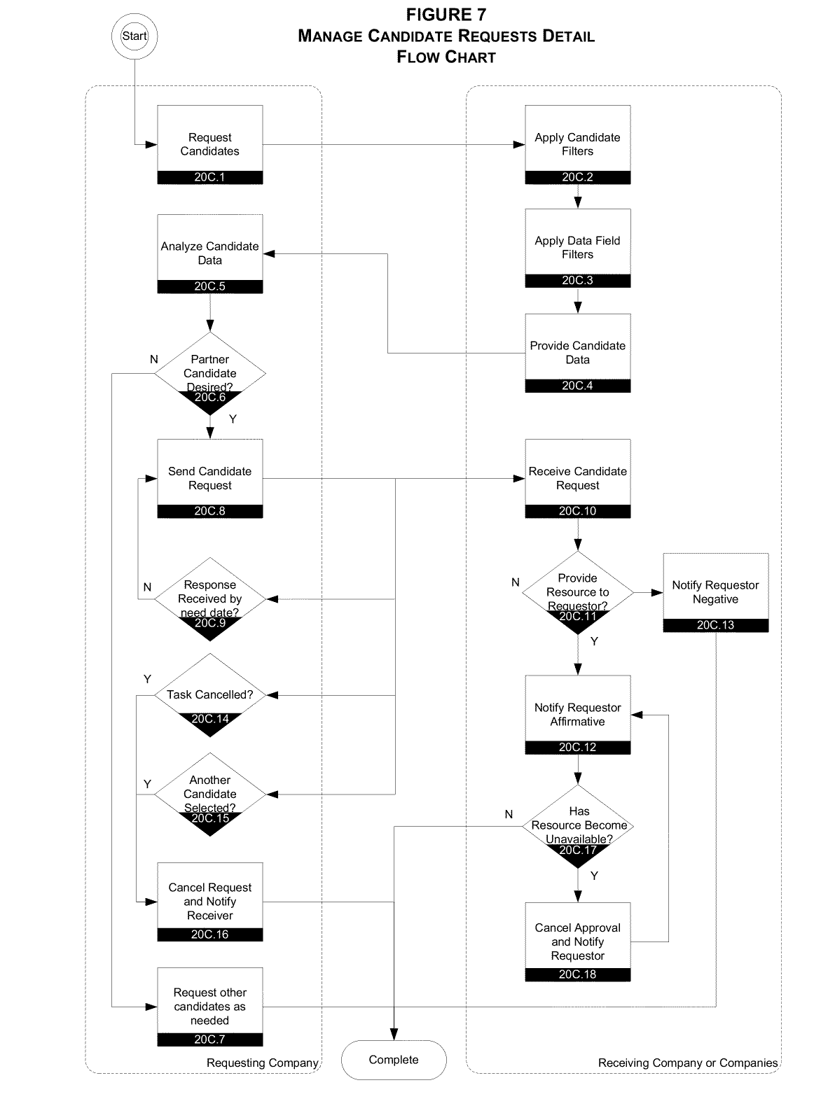

Once the method has established a connection between two or more companies' repositories of employee information, these companies can exploit that connection, via the method, for mutual benefit, by quickly and directly identifying those candidates within each other's companies that match an identified set of criteria, and then managing the employee request and fulfillment process. FIG. 7 is a second detail flow chart, expanding on a Block 20C in FIG. 2, describing how the method utilizes the connections established by it to provide candidate data and manage candidate requests which, in turn, enable timely staffing decisions within a collection of connected companies.

At a Request Candidates Block 20C.1, the method requests candidates, on behalf of a first company, from that company's collection of companies who have been connected by the method. This request is made electronically by communicating to the method the set of criteria that are desirable in the candidate, such as skills, professional certifications, security clearances, location, billing rate, and the like. The electronic request must be such that it is compatible with the common format used by all of the connected companies' databases; for example, a configurable, interactive form which lists some or all of the searchable data fields and the available selections for each field. Once configured, the method simultaneously applies the requested criteria to the company's own internal database and to all connected databases.

At an Apply Candidate Filters Block 20C.2, the method receives, on behalf of the companies connected to the first company by the method, a request for candidates which most closely match the set of search criteria garnered at Block 20C.1. A set of candidates may match the set of criteria; however, based on the database configuration set forth in Block 20A.12, a receiving company may have chosen not to share some or all of the matching candidates with the requesting company. The method applies this database configuration at Block 20C.2 to filter out those candidates.

Of the set of candidates that match the first company's criteria and pass through the candidate filter set forth in Block 20C.2, the receiving company may have chosen to hide some or all of the data about the candidates based on the database configuration set forth in Block 20A.12. At an Apply Data Field Filters Block 20C.3, the method applies this configuration to filter out those data fields.

At a Provide Candidate Data Block 20C.4, the method provides, to the requesting company, the candidates and data that match the request according to the candidate and data filters applied at blocks 20C.2 and 20C.3. The method delivers the candidate information in one or more myriad forms, for example, via email, or as raw data to a computer program designed to display such data.

At each of the Block 20C.2, Block 20C.3, and Block 20C.4 at least one server executes the method on behalf of the requesting company and its network of connected partner companies automatically and simultaneously with no manual intervention required at the time of the request by any company whatsoever.

At an Analyze Candidate Data Block 20C.5, an individual at the first company, and typically the individual who initiated the request, will analyze the candidate information provided by the method from the set of connected partner companies to determine if one of the candidates is desired. Once the analysis is complete, at a Partner Candidate Desired Block 20C.6, the individual decides if one of the candidates provided is suitable for the position in question.

In the case that a suitable candidate has not been provided, the request initiator can pursue other means of sourcing a suitable candidate, as set forth in a Request Other Candidates Block 20C.7. Alternative sourcing means can include reconfiguring the initial request through the method with modified search criteria, or engaging another means of sourcing candidates altogether, such as a specialized recruitment firm.

At a Send Candidate Request Block 20C.8, in the case that a suitable candidate has been identified, the request initiator can send a request for that candidate, via the method, to the company employing the desired candidate. The data present in this request consists of, at a minimum, the requesting company's name, the requesting individual's name, information about the task or job for which the candidate is being requested, and a timestamp corresponding to the date and time of the initiation of the request.

After a request is initially sent, the requesting company may desire to resend the request if it has not received a response in a timely fashion, represented by a Response Received by Need Date Decision Block 20C.9; this may be necessary if, for example, the request was not properly received by the intended recipient, or if the amount of activity at the receiving company impeded a timely response. The method provides this capability to the requesting company at the Block 20C.8 previously set forth.

At a Receive Candidate Request Block 20C.10, the method receives, on behalf of the company employing the candidate, the first company's request to engage that candidate. The method notifies the company employing the requested candidate of the request via one or more myriad electronic forms, for example, email, text message, and the like. Once the request has been received by the method on behalf of the receiving company, and individual at the receiving company will consider whether or not to supply that resource to the requesting company, represented by a Provide Resource to Requestor Decision Block 20C.11. Once the individual communicates the decision to the at least one server, the server performing method will relay the receiving company's decision to the requesting company, whether in the affirmative, represented by a Notify Requestor Affirmative Block 20C.12 or the negative, represented by a Notify requestor Negative Block 20C.13, via one or more myriad electronic mechanisms.

Circumstances may require the requesting company to cancel a request that has been initiated; this may come to pass if, for example, the project for which the candidate was requested is cancelled as shown at a Task Cancelled Decision Block 20C.14, or a different candidate is selected in the time between when the request was initiated and when it was considered as shown at an Another Candidate Selected Block 20C.15. At a Cancel Request and Notify Receiver Block 20C.16, the method provides the capability for the requesting company to cancel a previously initiated request and notify the receiving company of that cancellation via one or more myriad electronic mechanisms. Note that the Decision Blocks 20C.14 and 20C.15 represent only two of a great many reasons why a company may choose to cancel a previously initiated request for a partner's employee.

Similarly, at a Has Resource Become Unavailable Decision Block 20C.17, changing circumstances may result in the company receiving a request to decide to modify its initial affirmative response to that request; for example, a candidate who has been approved for an assignment may need to be reassigned based on an urgent need, or a candidate may simply leave the employ of the receiving company. At a Cancel Approval Block 20C.18, the method provides the capability for the receiving company to cancel a previously approved request and notify the requesting company of that cancellation via one or more myriad electronic mechanisms.

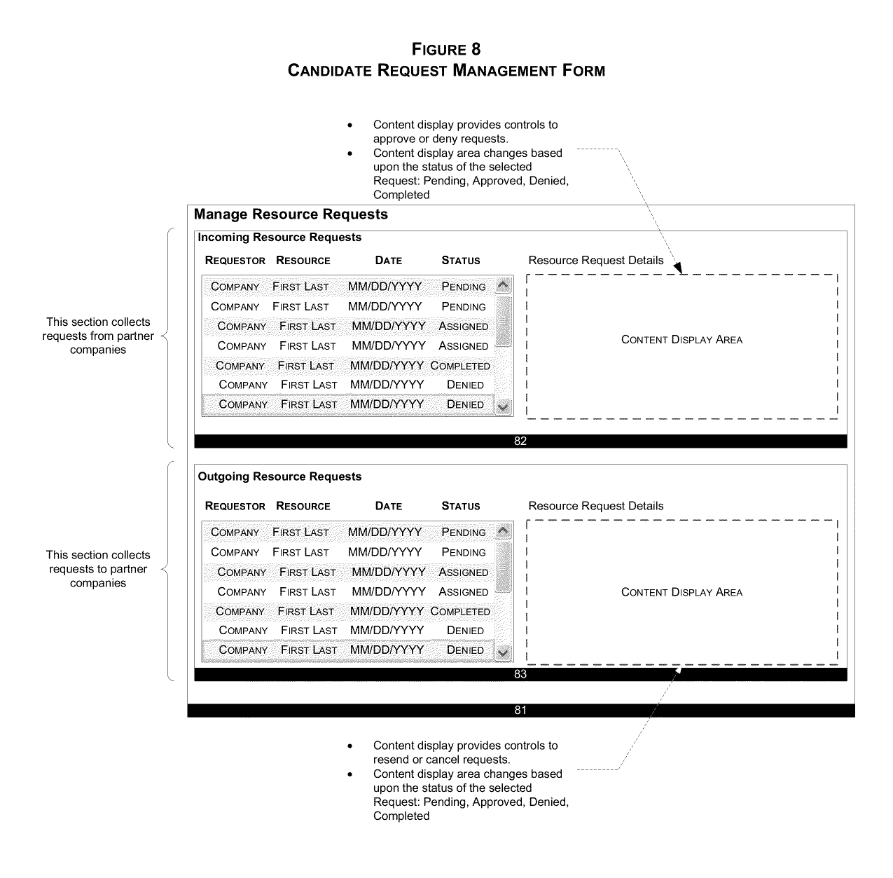

Depending on the demands placed upon them by their business environments, companies may both initiate and receive a great number of requests in a given time period. This may occur if, for example, a large government contract has recently solicited bids, and a large number of project teams have been requested and must be proposed for consideration. To facilitate the efficient review and disposition of candidate requests, the method provides a mechanism for companies to access all of the requests both sent and received by the method on their behalf in a centralized and cohesive manner. Such a mechanism can be implemented through an interactive form, a non-limiting example of which is shown in FIG. 8 at a Manage Resource Requests Block 81 and described in further detail below.

At an Incoming Resource Requests Block 82, the method collects and displays requests made for a company's resources by the method on behalf of a company's connected network of partners. Further, in the Block 82, the method provides the ability to manage the request as detailed in FIG. 7, including responding to the request in the affirmative as previously set forth at a Block 20C.12, responding to a request in the negative as previously set forth at a Block 20C.13, and cancelling a previously approved request as previously set forth at a Block 20C.18.

At an Outgoing Resource Requests Block 83, the method collects and displays requests made by a company for its partners' resources by the method. Further, in the Block 83, the method provides the ability to manage the request as detailed in FIG. 7, including resending a request as previously set forth at a Block 20C.8, and cancelling a previously initiated request as previously set forth at a Block 20C.7.

When accessing the means by which the method enables management of resource requests, the method may be configured to only provide access to a certain subset of requests depending upon the individual requesting that access. For example, the president of a company may have access to all incoming and outgoing requests, but a manager in that company may only have access to outgoing requests initiated, and incoming requests for resources that are directly managed, by that manager.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for providing employee information in response to queries by requesting companies in accord with searching rights granted by the employer, the method comprising:
receiving, at the at least one network-connected server, a query comprising at least one requested attribute from the requesting company, the requesting company having a role-based security profile relative to the partner company's employee database;
retrieving the role-based security profile of the requesting company to determine a subset of data from the partner company database comprising partner company employee data;
selectively collecting data based upon at least one employee attribute, selected to match the requested attribute and only to expose such of the data within the partner company employee database as is consistent with the role-based security profile, the data comprising records of selected employees the employee database contains; and
transmitting the collected data to the requesting company.

2. A non-transitory computer readable medium comprising instructions, which when executed by a process perform a method, the method comprising:
transmitting at least one requested attribute from a requesting company to a partner company;
retrieving a role-based security profile of the requesting company to determine a subset of partner company employee data selected from data in a partner company database the subset of partner company employee data selected in accord with the security profile;
collecting candidate employee data from the subset of the partner company database, candidate employee data having at least one employee attribute to match the requested attribute;
transmitting the candidate employee data to the requesting company.

3. The non-transitory computer readable medium of claim 2, wherein the new job is offered by a company and wherein the job candidate is a current employee of the company.

4. The non-transitory computer readable medium of claim 2, wherein the matching is by fuzzy matching and includes a matching score wherein the score is determined by comparing the requested attributes to the employee attributes.

5. The non-transitory computer readable medium of claim 4 wherein the matching score is determined based upon possessing a required certification.

6. The non-transitory computer readable medium of claim 4 wherein the matching score a requested attribute for a journeyman in a trade will allow a match an apprentice in the trade while reflecting a lower matching score that a journeyman in the trade would receive.

7. A non-transitory computer readable medium comprising instructions, which when executed by a process perform a method, the method comprising:
logging into a web-based active service page with a requesting company identity having a role-based security profile;
positing a query having at least one requested attribute, the query to locate at least one employee of a partner company in a partner company database;
developing access to a subset of the partner company database consistent with the role-based security profile;
identifying at least one employee from the subset of the partner company database, wherein the employee has at least one employee attribute matching the requested attribute.

8. A non-transitory computer readable medium comprising instructions, which when executed by a process perform a method for providing employee information in response to queries by requesting companies in accord with searching rights granted by the employer, the method comprising:
receiving a query comprising at least readable non-transitory memory residing within at least one network-connected server, a role-based security profile relative to the partner company's employee database; one requested attribute at the network-connected server, from the requesting company;
retrieving a role-based security profile of the requesting company to determine a subset of the partner company database comprising partner company employee data selected for access in accord with the security profile;
identifying within the subset of the partner company database candidate employee data having at least one employee attribute to match the requested attribute;
transmitting the candidate employee data to the requesting company.
